(19) United States
(12) Patent Application Publication
(10) Pub. No.: US 2007/0013802 A1
(43) Pub. Date: Jan. 18, 2007

(54) Display Panel Structure with Camera Function

(76) Inventors: Hsiang-Yuan Yang Chen, Tainan City (TW); Jin-Jie Yang, Tainan City (TW)

Correspondence Address: WPAT, PC;INTELLECTUAL PROPERTY ATTORNEYS, 2030 MAIN STREET, SUITE 1300, IRVINE, CA, 92614, US

(21) Appl. No.: 11/534,673

(22) Filed: Sep. 24, 2006

Related U.S. Application Data
(63) Continuation-in-part of application No. 11/150,202, filed on Jun. 13, 2005.

(51) Int. Cl. H04N 5/222

(52) U.S. Cl. 348/333.01

(57) ABSTRACT

A display panel structure with camera function is to install a video recording module at an extension section of an outer board of a panel module. A circuit board combining the circuit of the video recording module and the circuit of the panel module comprises a signal transmission member to transmit signals. The video recording module is formed integrally with the panel module to decrease manufacture cost.

### CROSS-REFERENCE TO RELATED APPLICATIONS

This application is a continuation-in-part of my application filed Jun. 13, 2005, Ser. No. 11/150,202, which is hereby incorporated by reference in its entirety.

### BACKGROUND OF THE INVENTION

1. Field of the Invention

This invention relates to a display panel structure with camera function, in particular to a panel module provided with a video recording module disposed at an extension section of an outer board of the panel module, and a circuit board combining the circuit of the panel module and the circuit of the video recording module to transmit signals through a signal transmission member.

2. Description of the Prior Art

There are a number of displays mounted with video camera lens on the market. The most popular one is a cellular phone with video recording capability.

In those products described above, their digital camera module is independent, meaning there are an independent circuit board and a signal transmission unit. The manufacturer of the finished product has to mount the digital camera lens to the casing of the product and connect the circuit signal transmission unit to the circuit board of the main unit.

Accordingly, an extra workstation is required in the process of the assembly of the digital camera to result in increased work hours and production costs; and the signal transmission unit of the digital camera module would have to occupy the connection port otherwise reserved for the circuit board of the main unit thus to reduce the mechanism of the main unit to enjoy externally connected expansion of resources. Furthermore, the digital camera module has to be squeezed into a limited space of the casing of the product to cause additional limitation to the design of the finished product while leaving a significant protrusion to its appearance to damage the aesthetic aspect of the finished product.

In some patents, such as US 2004/0212555 A1, U.S. Pat. No. 6,087,648 A, EP 1357726 A1, EP 1487196 A1, JP 2002-335432 A, provide video recording capabilities. In US 2004/0212555 A1, the video camera has to be isolated from the display and IC board with metal plated to maintain a clear vision of the camera. This increases the cost of manufacture.

U.S. Pat. No. 6,087,648 A discloses a semi-conduct procedure to connect the light sensing circuit and the driving circuit to the IC board, which does not disclose whether the display module and the video recording module are printed on the IC board integrally. Because the conventional display module and the video recording module are formed separately, there is no prior art to disclose combination of the two modules together. Currently, all known products are to have the two modules formed and mounted separately, which use different transmission systems and take more space in the casing.

As for EP 1357726 A1 and EP 1487196 A1, both patents claim video camera cellular phones. The cameras are mounted on the frame instead of underneath the display, which makes the assembly complicated and lacks for integral image.

JP 2002-335432 A discloses a cellular phone with an illumination device, which provides an instant light. The light is shining through the display, which can not provide a good lighting effect and the display blocks the camera from taking images.

### SUMMARY OF THE INVENTION

It is the primary objective of the present invention to provide a display panel structure with camera function, which combines a display module and a video recording module in one device that is easy to install and saves manpower.

It is another objective of the present invention to provide a display panel structure with camera function, which is cost-effective.

It is a further objective of the present invention to provide a display panel structure with camera function, which saves the product space and is convenient to design the appearance of a product.

According to the present invention, there is provided a display panel structure with camera function comprising:

a panel module comprising a display board and an outer board, said outer board being larger in size than said display board, said display board being tightly attached to said outer board, an extension section of said outer board being formed after said display board is attached to said outer board, said extension section being transparent;

a video recording module tightly attached to said extension section of said outer board of said panel module; and

a circuit board comprising a signal transmission member, said circuit board combining the circuit of said panel module and the circuit of said video recording module for said signal transmission member to transmit signals.

Preferably said circuit board is a soft board or a printed circuit board.

Preferably said extension section is provided with a pair of video recording modules.

Preferably said extension section is provided with a lighting member

### BRIEF DESCRIPTION OF THE DRAWINGS

FIG. 1 is a front view of the present invention;

FIG. 2 is a sectional view taken from line A-A of FIG. 1;

FIG. 3 is a front view showing the present invention applied to a cellular phone;

FIG. 4 is a front view showing the present invention applied to a PDA;

FIG. 5 is a front view showing the present invention applied to a LCD;

FIG. 6 is a front view showing the present invention applied to a dual-lens product; and

FIG. 7 is a front view showing the present invention applied to a product provided with a photoflash.

### DETAILED DESCRIPTION OF THE PREFERRED EMBODIMENTS

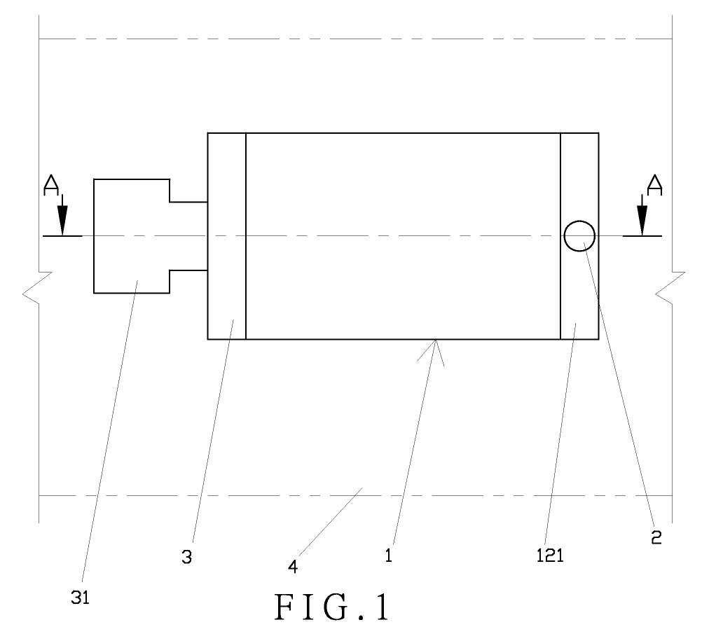

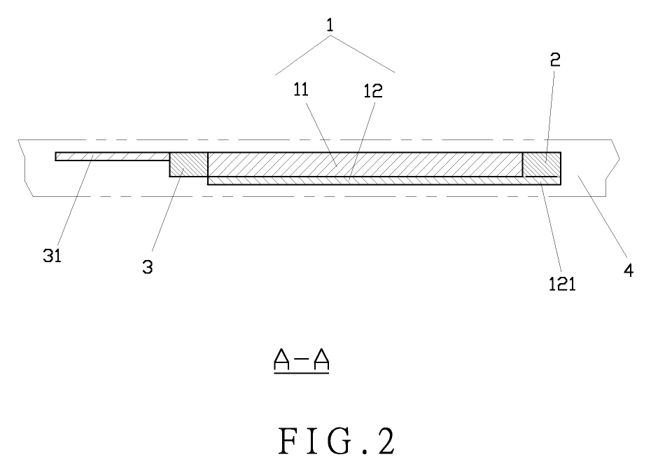

As shown in FIGS. 1 and 2, the present invention comprises a panel module (1), a video recording module (2), a circuit board (3) and a supporting member (4).

The panel module (1) comprises a display board (11) and an outer board (12). The outer board (12) is larger in size than the display board 11. The display board (11) is tightly attached to the outer board (12). The outer board (12) is provided with a transparent extension section (121) which is the section exceeding the panel module (1).

The video recording module (2) is tightly attached to the extension section (121) of the panel module (1).

The circuit board (3) is a soft board or a printed circuit board, and comprises a signal transmission member (31) and other electronic elements. The circuit board (3) combines the circuit of the panel module (1) and the circuit of the video recording module (2) together, and then transmits signals through the signal transmission member (31). The signals from the video recording module (2) are directly transmitted to a display module and a main IC board.

The above-mentioned modules are mounted on the supporting member (4). The supporting member (4) can be a frame or a casing of a product for the present invention to become an integral module.

The surface of the extension section (12) is coated, leaving only a lens area to permit the light. Accordingly, as the visual impression is concerned, the installation of a camera lens can hardly be observed to allow better visual impression to the user since only the display area is in vision.

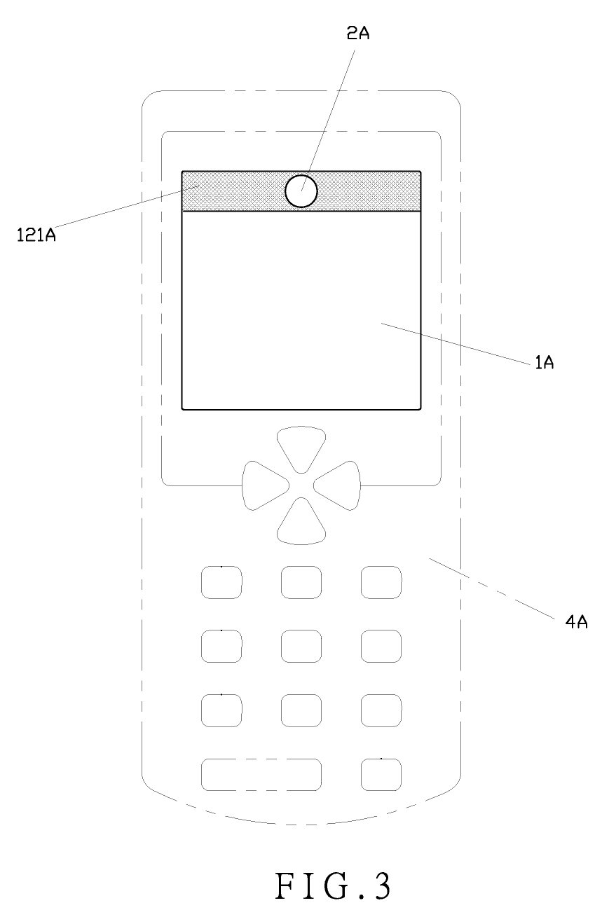

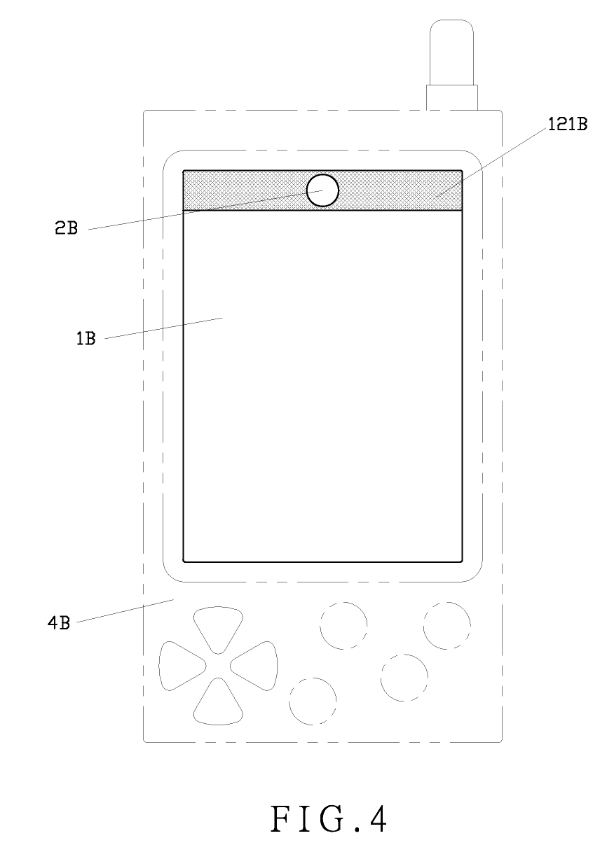

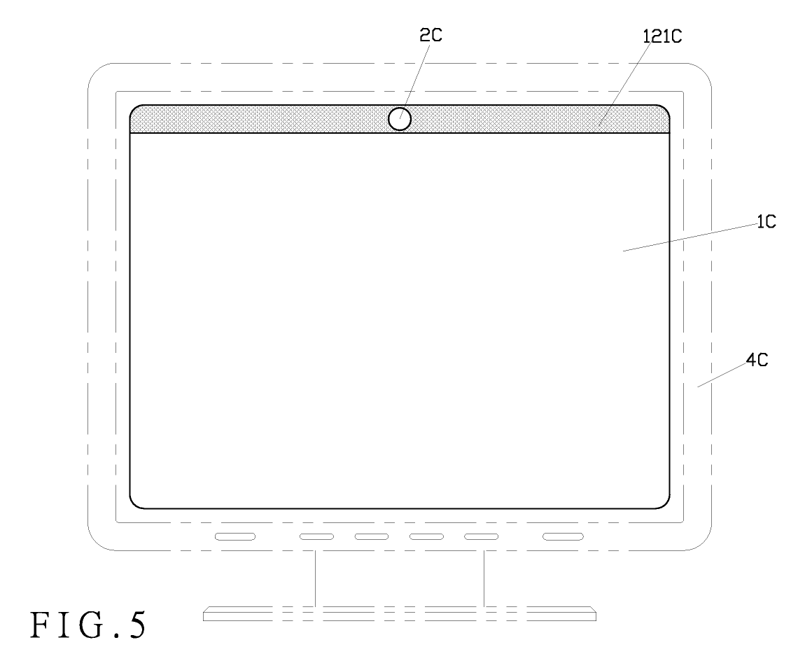

When applied, the panel module (1) of the present invention may be a flat display or other types of display including LCD (liquid crystal display), PDP (plasma display panel), FED (field emission display), LCOS (liquid crystal on silicon), OLED (organic light-emitting diode), EL (electro luminescent display), and SED (Surface-conduction Electron-emitter Display) applied to PC, TV set, cellular phone or monitor system. As illustrated in FIGS. 3, 4, and 5 in sequence for the schematic views of the present invention respectively applied to a cellular phone, PDA, and LCD, supporting members (4A, 4B, 4C) (including the frames of panel modules (1A, 1B, 1C)) are respectively provided to their respective casings of the products; and video recording modules (2A, 2B, 2C) are respectively disposed at their respective extension sections (121A, 121B, 121C) of outer boards (12A, 12B, 12C) of the panel modules (1A, 1B, 1C).

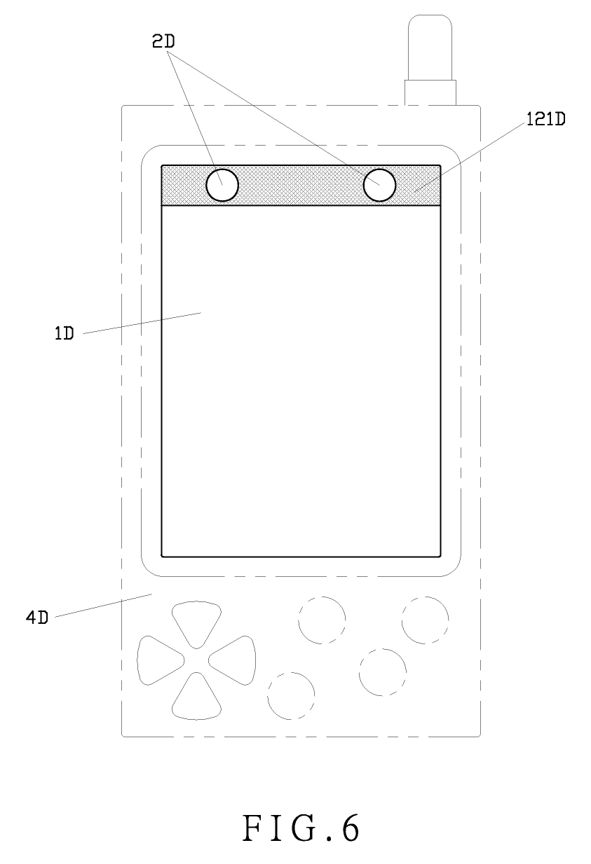

As illustrated in FIG. 6, the present invention is applied to a product provided with dual-lens. A casing of a LCD functions as a supporting member (4D) (including the frame of a panel module (1D)). Two video recording modules (2D) are disposed at an extension section (121D) of an outer board (12D) of the panel module (1D). The user while conducting a videoconference may provide 3D life-like images.

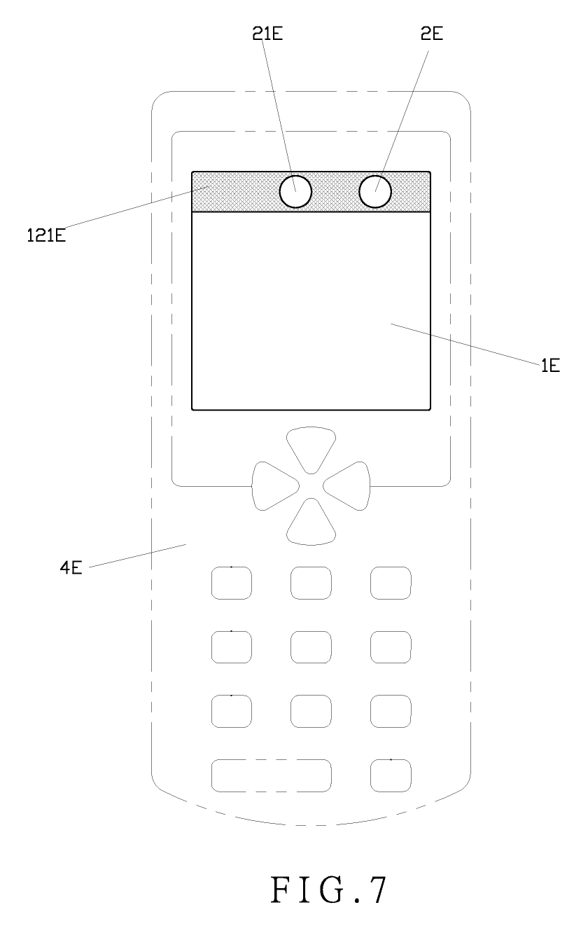

Now referring to FIG. 7 for a schematic view showing that the present invention is applied to a finished product provided with a photoflash. A casing of a cellular phone functions as a supporting member (4E) (including the frame of a panel module (1E)). A video recording module (2E) and a lighting member (21E) are disposed at an extension section (121E) of an outer board (12E) of the panel module (1E). The lighting member (21E) may be a photoflash or a LED (light emitting diode).

What is claimed is:

1. A display panel structure with camera function, comprising:
a panel module comprising a display board and an outer board, said outer board being larger in size than said display board, said display board being tightly attached to said outer board, an extension section of said outer board being formed after said display board is attached to said outer board, said extension section being transparent;
a video recording module tightly attached to said extension section of said outer board of said panel module; and
a circuit board comprising a signal transmission member, said circuit board combining the circuit of said panel module and the circuit of said video recording module for said signal transmission member to transmit signals.

2. The display panel structure with camera function, as recited in claim 1, wherein said circuit board is a soft board.

3. The display panel structure with camera function, as recited in claim 1, wherein said circuit board is a printed circuit board.

4. The display panel structure with camera function, as recited in claim 1, wherein said extension section is provided with a pair of video recording modules.

5. The display panel structure with camera function, as recited in claim 1, wherein said extension section is provided with a lighting member.
